(19) United States
(12) Patent Application Publication
(10) Pub. No.: US 2010/0057514 A1
(43) Pub. Date: Mar. 4, 2010

(54) EFFECTIVE TASK DISTRIBUTION IN COLLABORATIVE SOFTWARE DEVELOPMENT

(75) Inventors: Yi-Min Chee, Yorktown Heights, NY (US); Feng Liu, Beijing (CN); Qian Ma, Beijing (CN); Daniel V. Oppenheim, Croton on Hudson, NY (US); Krishna Ratakonda, Yorktown Heights, NY (US); Zhi Le Zou, Beijing (CN)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/201,073

(22) Filed: Aug. 29, 2008

(51) Int. Cl. G06F 7/00; G06F 7/36

(52) U.S. Cl. 705/8; 700/28; 700/213

(57) ABSTRACT

A method, system and computer program product are disclosed to support the dynamic (just-in-time) task distribution in the context of globally collaborative software development. Embodiments of the invention provide a method, system and computer program product for distributing tasks in a collaborative software development project, where said project has a multitude of work packets. An embodiment of the invention includes generating bidding request forms, and broadcasting the bidding request forms to a multitude of distributed teams; collecting completed bidding request forms having real-time information about attributes of the distributed teams; and matching eligible teams to the work packets. This embodiment further comprise optimizing a distribution plan of the work packets; ranking results of the distribution plan to give a final distribution plan; and notifying each of the distributed teams of any work packets assigned to them.

### BACKGROUND OF THE INVENTION

1. Field of the Invention

This invention generally relates to collaborative software development, and more specifically, to task distribution to support collaborative software development.

2. Background Art

The distribution of tasks among different practitioners is an indispensable requirement in the emerging globally collaborative development lifecycle. Software development organizations are being modularized and the tasks of a project are then distributed to the appropriate participants. Traditionally, software development organizations may compare the task's requirement and the practitioner's capability to make a decision before the actual distribution.

However, task distribution becomes more complex in today's globally collaborative development context. A big challenge comes from the open and dynamic collaborative environment. Under this environment, software development organizations need not only look for appropriate execution teams based on their capabilities, but also need to consider the non-functional attributes of different teams. For example, the runtime availabilities of various teams should be carefully taken into account when these organizations try to distribute the development tasks. In addition, some characteristics of different teams, such as development time and cost, are dynamically changeable during the task distribution. Some teams may produce more reliable and robust artifacts but require more time and are more expensive. Other teams may excel at availability and fast turn-around. In summary, the global software development is essentially an intra/inter-enterprise collaborative process. The run-time status of different distributed teams typically cannot be controlled by a central management organization—so, decentralized scheduling becomes necessary. Therefore, these non-functional factors have a great effect on the task distribution during globally collaborative development. It is important to understand how to support effectively the task distribution in this open and dynamical inter-enterprise collaborative environment.

### SUMMARY OF THE INVENTION

This invention provides a method, system and computer program product to support the dynamic (just-in-time) task distribution in the context of globally collaborative software development. More specifically, embodiments of the invention provide a method, system and computer program product for distributing tasks in a collaborative software development project, where said project has a multitude of work packets.

An embodiment of the invention includes generating bidding request forms for the work packets, and broadcasting the bidding request forms to a multitude of distributed teams; collecting from at least some of the distributed teams, completed bidding request forms having real-time information about functional and non-functional attributes of the distributed teams; and matching eligible distributed teams to the work packets based on given mandatory conditions. This embodiment further comprise optimizing a task distribution plan of the work packets to the distributed teams based on said real-time information collected from different ones of the distributed teams; ranking results of the task distribution plan to give a final distribution plan of the work packets to the distributed teams; and notifying each of the distributed teams of any work packets assigned to said each distributed team.

Important aspects of embodiments of the invention include a bidding approach to collect both functional (capability etc) and non-functional information from distributed teams, a dynamic selection method to choose the appropriate “execution unit” team during runtime, a multi-dimensional (multi-perspective) measurement system for describing EU's non-functional information, and a process adoption method that can swap teams in and out of certain activities as team, with some restrictions specified in the bidding process, as team availability changes.

### BRIEF DESCRIPTION OF THE DRAWINGS

FIG. 1 shows a high-level architecture of a system embodying this invention.

FIG. 2 depicts a sample bidding request form that may be used in the present invention.

FIG. 3 illustrates the process flow of an embodiment of the invention.

FIG. 4 shows a computing environment that may be used to implement this invention.

### DETAILED DESCRIPTION OF THE PREFERRED EMBODIMENTS

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments of the invention provide a method, system, and computer program product to support the task distribution under the context of global collaborative software development. Through the global collaboration, a software development project is divided into a series of sub-tasks that are outsourced to different participants in different organizations. Software development organizations hope this kind of global delivery can decrease the time to market and the cost structure. However, unlike a traditional collaborative environment, the globally collaborative environment is typically open and dynamic. The “outsourcing” is often across the bound of enterprises so that the state of different practitioners can not be controlled by software development organizations. Therefore, besides the static attributes such as capability, the dynamically changeable information of available resources should also be carefully taken into account before assigning a specific development task. Otherwise, the overall distribution plan is not optimal and may not even be feasible at run-time. Compared with existing task distribution methods, the following dynamic, non-functional attributes are combined into the resource selection: the run-time availability of different teams (as opposed to static availability used by most scheduling algorithms) and historical information collected from teams that relate to their performance and experience.

Embodiments of the invention provide a bidding approach to handle the task distribution in a dynamically collaborative environment. Key aspects of this are discussed below.

The whole project development work is partitioned into several parts. Each part is named as a Work Packet (WP) which refers to an encapsulation of a development task containing explicit interface definitions, complete documents for its inputs and deliverables, clear capability requirement and other conditions. The requirements for a WP are formatted as a bidding request form and published into an open collaborative forum (such as the internet or intranet) or broadcasted to specific open communities. Note that the WP itself may be standardized through an organization, so that different business units share the same understanding of its nature and scope.

Any global team that is interested may bid for this WP. This bid process may be explicit (in response to the bid request) or implicit (by directly matching capabilities available in a team profile stored in a database). In the latter case, searching for a team at run time is akin to dynamic binding of web services to specific server instances at run time in the context of service oriented architectures. Typically, a team will need to provide information about its capability, work duration, cost, etc., as a bid response. In a departure from existing scheduling tools where the scheduling happens in the beginning, the dynamic information from the team, such as related current skill composition of the team, real time availability etc. are also gathered as part of the bid process.

Multi-perspective measurements of the historical team performance are retrieved from a centralized database—these collate performances from individual resources constituting the team as well as the performance these resources in the context of this team. Also, the team is measured across multiple perspectives—from schedule adherence, quality of work done, relative cost (with respect to other available teams and baseline).

The team is bound to the WPs. In this stage, certain WPs may allow for dynamic swapping of teams as the availability changes. This adaptability of the process ensures that as team availability or resource composition changes, action can be quickly taken to remedy impending problems.

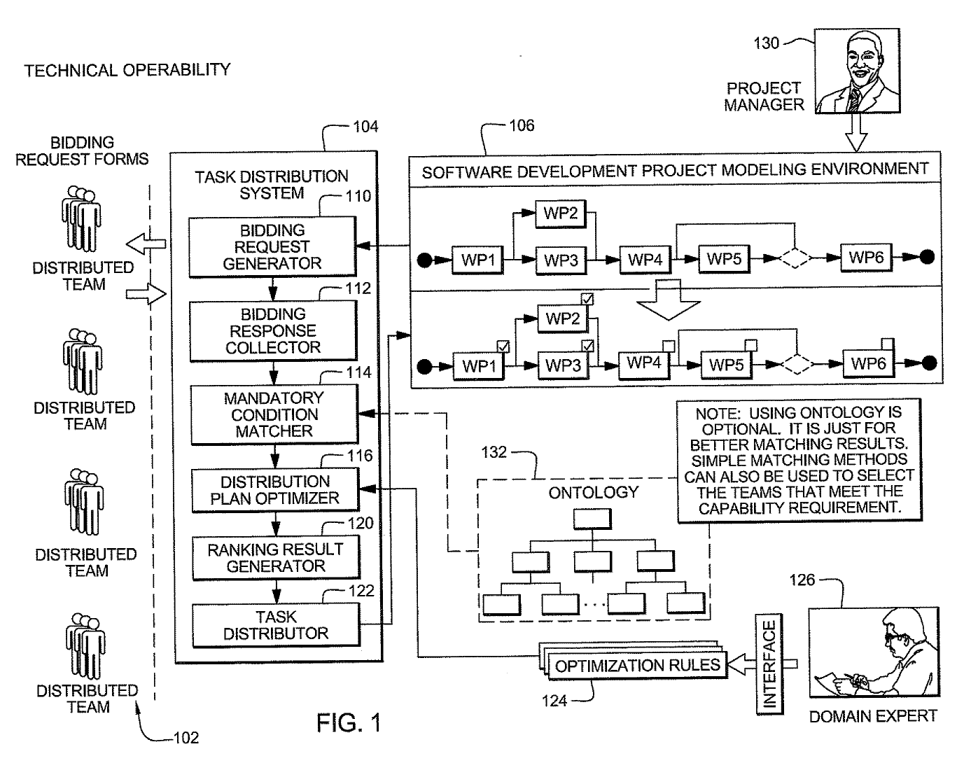

The objective of this invention is to effectively distribute the development tasks of a software project into different participants under the global collaborative environment. In this global delivery context, not only the capabilities of different distributed teams should be matched to the tasks' requirements, but also the real-time information, such as work duration and cost, would be carefully considered when building a task distribution plan. The basic idea of this invention is to provide a bidding mechanism through the task distribution process. This mechanism firstly publishes a bidding request form to describe the requirements for a specific development task, and then collect the real-time information of different distributed teams through their bidding responses, including capability, work duration, cost and other information. Finally, the task distribution system in this invention would generate an appropriate task distribution plan based on the runtime information. The high level process and architecture is shown in the FIG. 1.

FIG. 1 shows a series of distributed teams 102, the task distribution system 104, and a software development project modeling environment 106. The Task Distribution System, in turn, includes a series of components, including a Bidding Request Generator 110, a Bidding Response Collector 112, a Mandatory Condition Matcher 114, a Distribution Plan Optimizer 116, a Ranking Result Generator 120, and a Task Distributor 122. FIG. 1 also shows a series of optimization rules 124, a Domain Expert 126, a Project Manager 130, and an ontology 132.

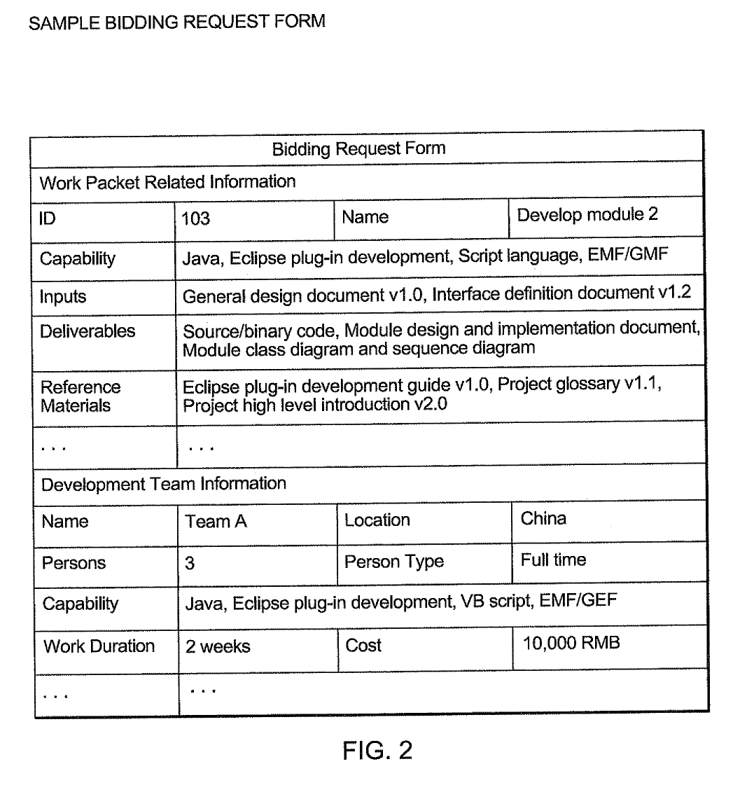

Two important apparatuses in this embodiment of the invention are the Bidding Request Generator and Bidding Response Collector. They enable the basic bidding process for task distribution. As mentioned above, the project manager may use some modeling tools to define the development process of a specific software project. In these tools, the project manager divides the whole project into a series of Work Packets (WPs). Each WP becomes a modularized task and clearly defines what work is needed to be done. It is assigned into a qualified remote team to finish it. After the modularization, the Bidding Request Generator generates a bidding request form to collect the runtime information from potential participants. This form describes related information for a specific WP, including capability requirement, inputs, deliverables, reference documents and other useful materials. The bidding request form may be published though some web application portal into the Internet. FIG. 2 gives an example of the bidding request form in one embodiment.

Any distributed teams who are interested in the WP development may fill in their own information into the bidding request form. The Bidding Response Collector collects the above information until the bidding period expires. The bidding process typically decouples the communication between the task distribution system and the distributed teams, so that any new teams can easily join in and any existing teams can easily withdraw dynamically. All the bidding responses may be used to build up an appropriate task assignment plan.

Similar with traditional task distribution methods, the Mandatory Condition Matcher firstly selects the eligible development team according to the WP's basic requirement, such as the capability. The basic requirement is often mandatory and static, so this step is used to reduce the search space of appropriate resources. In another embodiment of this invention, some semantic technology can be used in the Mandatory Condition Matcher to increase the matching quality by preventing the task distribution system from the simple literal way. For instance, if ontology is used to define “VB script” as a kind of “script language”, a successful matching result can be built between the WP and the distributed team in the above bidding form.

Another key component of this embodiment of the invention is the Distributed Plan Optimizer, which differentiates the proposed method from traditional task distribution methods. According to the matching result from the Mandatory Condition Matcher, eligible teams are found for executing a specific task. This is the same with previous methods. However, in the open and dynamical globally collaborative environment, this simple matching result is usually not feasible and optimal. The task distribution system wants to select the most appropriate resources based on the real-time status of different distributed teams. In one embodiment, the work duration and the development cost are considered as an example.

These kinds of information are dynamically changeable and may be collected timely through the bidding responses. The task distribution system would like to choose the team whose work duration is shorter and the cost is lower. Here, some domain experts could input corresponding optimization rules into the optimizer. The optimizer would use the real-time information to decide the best resources according to the rules.

For instance, the following rules can be adopted to select an optimal bid. When the project manager designs the development process for a software project, he may define the expected work duration and cost for each WP in order to make sure that the whole project meets the schedule. We define:
T_{aggr}_{_{—}}ₚₗₐₙ—The expected aggregated work duration before current development task.
T_{curr}_{_{—}}ₚₗₐₙ—The expected work duration of current development task.
C_{aggr}_{_{—}}ₚₗₐₙ—The expected aggregated cost before current development task.
C_{curr}_{_{—}}ₚₗₐₙ—The expected cost of current development task.

After the bidding for development tasks, we have:
T_{aggr}_{_{—}}_{bid}—The aggregated work duration before current development task after a series of bidding.
T_{curr}_{_{—}}_{bid}—The work duration of current development task after bidding.
C_{aggr}_{_{—}}_{bid}—The aggregated cost before current development task after a series of bidding.
C_{curr}_{_{—}}_{bid}—The cost of current development task after bidding.

The system, in an embodiment, cares about whether the development process has been overrun before distributing a specific task. Therefore, we provide duration overrun ratio (DOR) and cost overrun ratio (COR) are provided to describe the degree of process overran.

$$DOR = \frac{{T}_{aggr\_bid} + {T}_{curr\_bid}}{{T}_{aggr\_plan} + {T}_{curr\_plan}}$$

$$COR = \frac{{C}_{aggr\_bid} + {C}_{curr\_bid}}{{C}_{aggr\_plan} + {C}_{curr\_plan}}$$

The bidding winner as:
bidding_winner=min(f(αDOR,βCOR)), where f(αDOR,βCOR)>0.

The coefficients α, β can be used to adjust the weight between the work duration and the development cost. The evaluation of each distributed team that attends the bidding process provides a ranking list among different teams. The best resource will be selected to execute the development task.

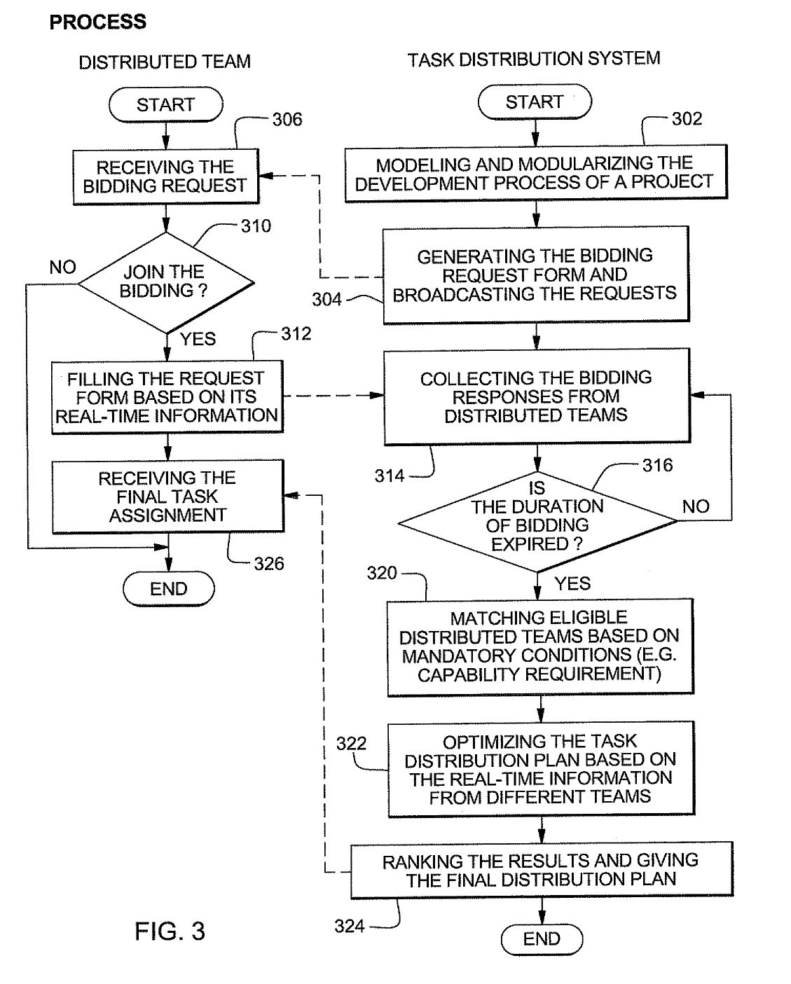

FIG. 3 shows a process flow of an embodiment of the invention. This process flow illustrates steps performed by the Task Distribution System and steps performed by a Distributed Team. At step 302, the Task Distribution System models and modularizes the development process of a project; and at step 304, the Task Distribution System generates the bidding request form and broadcasts the request.

The Distributed Team, at step 306, receives the bidding request and, at step 310, decides whether or not to join the bidding. If the Team decides not to join, the process ends for the Team. However, if the Distributed Team decides to join the bidding process, that Team, at step 312, fills the request form based on its real-time information, and the completed form is sent to the Task Distribution System.

The Task Distribution System collects the bidding responses from the Distributed Teams at step 314. At step 316, the Task Distribution System determines if the duration of the bidding has expired. The Task Distribution System loops through steps 314 and 316 until the duration of the bidding expires. Once that bidding has expired, the Task Distribution System, at step 320, matches eligible Distributed Teams based on mandatory conditions, such as a capability requirement. At step 322, the task distribution plan is optimized based on the real-time information from different Distributed Teams. At step 324, the Task Distribution system ranks the results and gives out the final distribution plan. Each of the Distributed Teams receives their final task assignment at step 326.

Embodiments of the invention provide a number of important advantages. For instance, embodiments of the invention effectively tackle the dynamic availability of distributed teams: How many teams would join in and what teams would join in is decided by the bidding responses during runtime, and thus the bidding represents the situation of the current environment. The teams currently unavailable would not attend the bidding. Any new teams can easily join in the bidding and any existing teams can easily withdraw dynamically.

Also, embodiments of the invention effectively plan the software development project and “just-in-time” allocate tasks based on the real-time information: The distributed teams can express their current status and interest through the bidding process. The task distribution system can gain the intrinsic-changed information, such as work duration, cost, and etc., through the bidding process. Based on this information, the system can generate a more appropriate project plan. The traditional method which merely depends on relatively static information is not sufficient and accurate in the globally collaborative environment.

In addition, embodiments of the invention non-invasively retrieve runtime information. Due to the fact that global collaborative software development is often inter-enterprise, so it is almost not feasible to detect all the runtime information of other enterprises. The bidding process provides a platform for joining teams to input their information. The task distribution system can use effective algorithm to analyze this real-time information. The teams can even combine their consideration on other factors into input values to describe their desires. Another advantage provided by embodiments of the invention is the ability to adapt to dynamic changes in project status: A team having a problem can easily be replaced. Also, if the work load is larger than expected, the developer can bid for additional help.

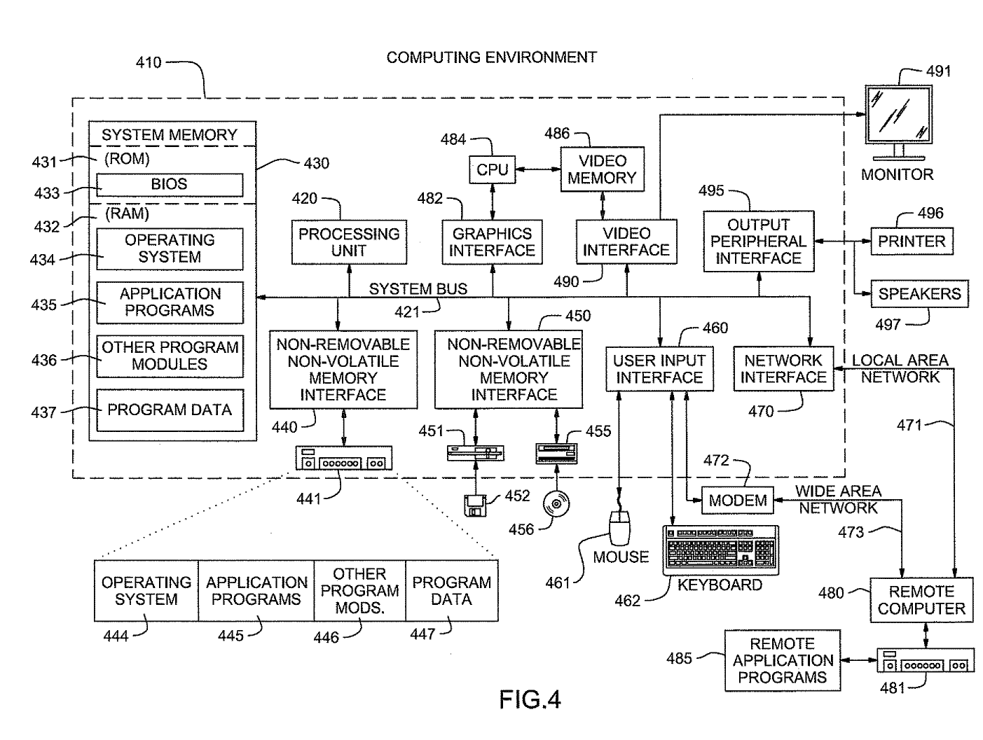

For example, FIG. 4 and the following discussion provide a brief general description of a suitable computing environment in which the invention may be implemented. It should be understood, however, that handheld, portable, and other computing devices of all kinds are contemplated for use in connection with the present invention. While a general-purpose computer is described below, this is but one example, the present invention may be implemented in an environment of networked hosted services in which very little or minimal client resources are implicated, e.g., a networked environment in which the client device serves merely as a browser or interface to the World Wide Web.

Although not required, the invention can be implemented via an application-programming interface (API), for use by a developer, and/or included within the network browsing software, which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations.

Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 4, thus, illustrates an example of a suitable computing system environment 400 in which the invention may be implemented, although as made clear above, the computing system environment 400 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

With reference to FIG. 4, an exemplary system for implementing the invention includes a general purpose-computing device in the form of a computer 410. Components of computer 410 may include, but are not limited to, a processing unit 520, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 410 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 510.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable, volatile/nonvolatile computer storage media. By way of example only, FIG. 4 illustrate a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 521 by a removable memory interface, such as interface 450.

The drives and their associated computer storage media discussed above and illustrated in FIG. 4 provide storage of computer readable instructions, data structures, program modules and other data for the computer 410. In FIG. 4, for example, hard disk drive 441 is illustrated as storing operating system 444, application programs 545, other program modules 546, and program data 447. Note that these components can either be the same as or different from operating system 434, application programs 435, other program modules 436, and program data 537. Operating System 444, application programs 445, other program modules 446, and program data 447 are given different numbers here to illustrate that, at a minimum, they are different copies.

A user may enter commands and information into the computer 410 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus 421, but may be connected by other interface and bus structures, such as a parallel port, game port or a universal serial bus (USB).

A monitor 491 or other type of display device is also connected to the system bus 421 via an interface, such as a video interface 490. A graphics interface 482, such as Northbridge, may also be connected to the system bus 421. Northbridge is a chipset that communicates with the CPU, or host-processing unit 420, and assumes responsibility for accelerated graphics port (AGP) communications. One or more graphics processing units (GPUs) 484 may communicate with graphics interface 482. In this regard, GPUs 484 generally include on-chip memory storage, such as register storage and GPUs 484 communicate with a video memory 486. GPUs 484, however, are but one example of a coprocessor and thus a variety of co-processing devices may be included in computer 410. A monitor 491 or other type of display device is also connected to the system bus 421 via an interface, such as a video interface 490, which may in turn communicate with video memory 486. In addition to monitor 491, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a routers a network PC, a peer device or other common network node, and typically includes many or all of the elements described above relative to the computer 410, although only a memory storage device 481 has been illustrated in FIG. 4. The logical connections depicted in FIG. 4 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on memory device 481. It will be appreciated that the network connections shown are exemplary and other means of establishing a communications link between the computers may be used.

One of ordinary skill in the art can appreciate that a computer 410 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

While it is apparent that the invention herein disclosed is well calculated to fulfill the objects discussed above, it will be appreciated that numerous modifications and embodiments may be devised by those skilled n the art, and it is intended that the appended claims cover all such modifications and embodiments as fall within the true scope of the present invention.

What is claimed is:

1. A method of distributing tasks in a collaborative software development project, said project having a multitude of work packets, the method comprising:
generating bidding request forms for the work packets, and broadcasting the bidding request forms to a multitude of distributed teams;
collecting from at least some of the distributed teams, completed bidding request forms having real-time information about functional and nonfunctional attributes of the distributed teams;
matching eligible distributed teams to the work packets based on given mandatory conditions;
optimizing a task distribution plan of the work packets to the distributed teams based on said real-time information collected from different ones of the distributed teams;
ranking results of the task distribution plan to give a final distribution plan of the work packets to the distributed teams; and
notifying each of the distributed teams of any work packets assigned to said each distributed team.

2. The method according to claim 1, further comprising dynamically swapping some of the distributed teams that are assigned to some of the work packets during the development project as the availability of the distributed teams change.

3. The method according to claim 1, wherein the optimizing a task distribution plan includes inputting optimization rules and using the optimization rules and said real-time information to optimize the task distribution plan.

4. The method according to claim 1, wherein the optimizing a task distribution plan includes assigning each of the work packets to one of the distributed teams based on a work duration and a development cost of said each work packet.

5. The method according to claim 4, wherein the optimizing a task distribution plan includes assigning each of the work packets to one of the distributed teams further based on:
t_{aggr}_{_{—}}ₚₗₐₙ—The expected aggregated work duration before current development task,
T_{curr}_{_{—}}ₚₗₐₙ13 The expected work duration of current development task,
C_{aggr}_{_{—}}ₚₗₐₙ—The expected aggregated cost before current development task, and
C_{curr}_{_{—}}ₚₗₐₙ—The expected cost of current development task.

6. The method according to claim 5, wherein the optimizing a task distribution plan includes assigning each of the work packets to one of the distributed teams further based on:
T_{aggr}_{_{—}}_{bid}—The aggregated work duration before current development task after a series of bidding,
T_{curr}_{_{—}}_{bid}—The work duration of current development task after bidding,
C_{aggr}_{_{—}}_{bid}—The aggregated cost before current development task after a series of bidding, and
C_{curr}_{_{—}}_{bid}—The cost of current development task after bidding.

7. The method according to claim 6, wherein the optimizing a task distribution plan includes assigning each of the work packets to one of the distributed teams further based on the ratios:
$$DOR = \frac{{T}_{aggr\_bid} + {T}_{curr\_bid}}{{T}_{aggr\_plan} + {T}_{curr\_plan}}$$
$$COR = \frac{{C}_{aggr\_bid} + {C}_{curr\_bid}}{{C}_{aggr\_plan} + {C}_{curr\_plan}}$$

8. The method according to claim 7, wherein the optimizing a task distribution plan includes assigning each of the work packets to the one of the distributed teams having, for said each work packet, the min(f(αDOR,βCOR)), where f(αDOR,βCOR)>0
where α and β are selected weighting coefficients.

9. The method according to claim 1, wherein each of the bidding request forms describes information for a specific one of the work packets, including capability requirements, inputs, deliverables and reference documents.

10. The method according to claim 1, wherein the matching eligible distributed teams to the work packets includes using semantic technology to increase the matching quality by preventing only literal interpretation of information in the bidding request forms.

11. A task distribution system for distributing tasks in a collaborative software development project, said project having a multitude of work packets, the system comprising:
a bidding request generator for generating bidding request forms for the work packets, and broadcasting the bidding request forms to a multitude of distributed teams;
a bidding request collector for collecting from at least some of the distributed teams, completed bidding request forms having real-time information about functional and non-functional attributes of the distributed teams;
a mandatory condition matcher for matching eligible distributed teams to the work packets based on given mandatory conditions;
a distribution plan optimizer for optimizing a task distribution plan of the work packets to the distributed teams based on said real-time information collected from different ones of the distributed teams;
a ranking result generator for ranking results of the task distribution plan; and
a task distributor for give a final distribution plan of the work packets based on said ranking results.

12. The system according to claim 11, wherein the distribution plan optimizer uses given optimization rules and said real-time information to optimize the task distribution plan.

13. The system according to claim 11, wherein task distributor assigns each of the work packets to one of the distributed teams further based on:
T_{aggr}_{_{—}}ₚₗₐₙ—The expected aggregated work duration before current development task,
T_{curr}_{_{—}}ₚₗₐₙ—The expected work duration of current development task,
C_{aggr}_{_{—}}ₚₗₐₙ—The expected aggregated cost before current development task,
C_{curr}_{_{—}}ₚₗₐₙ—The expected cost of current development task,
T_{aggr}_{_{—}}_{bid}—The aggregated work duration before current development task after a series of bidding,
T_{curr}_{_{—}}_{bid}—The work duration of current development task after bidding,
C_{aggr}_{_{—}}_{bid}—The aggregated cost before current development task after a series of bidding, and
C_{curr}_{_{—}}_{bid}—The cost of current development task after bidding.

14. The method according to claim 13, wherein task distributor assigns each of the work packets to one of the distributed teams further based on the ratios:
$$DOR = \frac{{T}_{aggr\_bid} + {T}_{curr\_bid}}{{T}_{aggr\_plan} + {T}_{curr\_plan}}$$
$$COR = \frac{{C}_{aggr\_bid} + {C}_{curr\_bid}}{{C}_{aggr\_plan} + {C}_{curr\_plan}}$$

15. The system according to claim 11, wherein the mandatory condition matcher uses semantic technology to increase the matching quality by preventing only literal interpretation of information in the bidding request forms.

16. An article of manufacture comprising:
at least one computer usable medium having computer readable program code logic to execute a machine instruction in one or more processing units for distributing tasks in a collaborative software development project, said project having a multitude of work packets, the computer readable program code logic, when executing, performing the following:
generating bidding request forms for the work packets, and broadcasting the bidding request forms to a multitude of distributed teams;
collecting from at least some of the distributed teams, completed bidding request forms having real-time information about functional and non-functional attributes of the distributed teams;
matching eligible distributed teams to the work packets based on given mandatory conditions;
optimizing a task distribution plan of the work packets to the distributed teams based on said real-time information collected from different ones of the distributed teams;
ranking results of the task distribution plan to give a final distribution plan of the work packets to the distributed teams; and
notifying each of the distributed teams of any work packets assigned to said each distributed team.

17. The article of manufacture according to claim 16, wherein the computer readable program code logic, when executing, further performs dynamically swapping some of the distributed teams that are assigned to some of the work packets during the development project as the availability of the distributed teams change.

18. The article of manufacture according to claim 16, wherein the optimizing a task distribution plan includes assigning each of the work packets to one of the distributed teams based on:
T_{aggr}_{_{—}}ₚₗₐₙ—The expected aggregated work duration before current development task,
T_{curr}_{_{—}}ₚₗₐₙ—The expected work duration of current development task,
C_{aggr}_{_{—}}ₚₗₐₙ—The expected aggregated cost before current development task,
C_{curr}_{_{—}}ₚₗₐₙ—The expected cost of current development task,
T_{aggr}_{_{—}}_{bid}—The aggregated work duration before current development task after a series of bidding,
T_{curr}_{_{—}}_{bid}—The work duration of current development task after bidding,
C_{aggr}_{_{—}}_{bid}—The aggregated cost before current development task after a series of bidding, and
C_{curr}_{_{—}}_{bid}—The cost of current development task after bidding.

19. The article of manufacture according to claim 18, wherein the optimizing a task distribution plan includes assigning each of the work packets to one of the distributed teams further based on the ratios:
$$DOR = \frac{{T}_{aggr\_bid} + {T}_{curr\_bid}}{{T}_{aggr\_plan} + {T}_{curr\_plan}}$$
$$COR = \frac{{C}_{aggr\_bid} + {C}_{curr\_bid}}{{C}_{aggr\_plan} + {C}_{curr\_plan}}$$

20. The article of manufacture according to claim 16, wherein the matching eligible distributed teams to the work packets includes using semantic technology to increase the matching quality by preventing only literal interpretation of information in the bidding request forms.
